(19) United States
(12) Patent Application Publication
(10) Pub. No.: US 2015/0078964 A1
(43) Pub. Date: Mar. 19, 2015

(54) VOLATILE ORGANIC COMPOUND REMOVER ASSEMBLY

(71) Applicant: ENVERID SYSTEMS, INC., NEWTON, MA (US)

(72) Inventors: Udi Meirav, Newton, MA (US); Israel Biran, Avihail (IL)

(73) Assignee: ENVERID SYSTEMS, INC., NEWTON, MA (US)

(21) Appl. No.: 14/394,080

(22) PCT Filed: Apr. 10, 2013
(86) PCT No.: PCT/US2013/035933

§ 371 Date: Oct. 10, 2014

Related U.S. Application Data
(60) Provisional application No. 61/622,016, filed on Apr. 10, 2012.
(60) Provisional application No. 61/704,815, filed on Sep. 24, 2012.
(60) Provisional application No. 61/703,739, filed on Sep. 20, 2012.

(51) Int. Cl. B01D 53/04

(52) U.S. Cl. CPC B01D 53/04; B01D 2253/10; B01D 2253/20; B01D 2253/116; B01D 2257/708; B01D 2259/4508
USPC 422/120; 96/144; 95/141; 96/116

(57) ABSTRACT

Some embodiments of the present disclosure provide an air treatment assembly including a sorbent, such as a carbon fiber cloth, for cleansing circulating indoor air of VOCs. Accordingly, in some embodiments, the air treatment assembly is provided and may be configured for in-situ regeneration, using outside air to flush a sorbent and purge the air treatment assembly in a repeatable adsorption-regeneration cycle, allowing a relatively small mass of sorbent to be used for an extended period of time.

### CROSS REFERENCE TO RELATED APPLICATIONS

This application claims priority to: U.S. Provisional Patent Application No. 61/622016, filed Apr. 10, 2012 and entitled “Air Cleaning Assembly”; U.S. Provisional Patent Application No. 61/704815, filed Sep. 24, 2012 and entitled “Volatile Organic Compound Remover Assembly” and U.S. Provisional Patent Application No. 61/703739, filed Sep. 20, 2012 and entitled “Method and System for Monitoring Indoor Air Quality”. The disclosures of the above applications are incorporated herein by reference in their entireties.

### TECHNICAL FIELD

Embodiments of the present disclosure generally relate to air treatment and more particularly to Volatile Organic Compound (VOC) removal from indoor environments.

### BACKGROUND

Indoor air within and around buildings and other closed spaces is affected by a plurality of contaminants. Among these contaminants are a group of species of organic vapors, broadly referred to as Volatile Organic Compounds (VOC). The sources of these vapors include, inter alia, the human occupants themselves—from respiration and perspiration to clothing and cosmetics—as well as building materials, equipment, food and consumer products, cleaning materials, office supplies or any other materials emitting VOCs. Other contaminant include inorganic gases such as carbon dioxide (CO₂), nitrous oxides, carbon monoxide, sulfur dioxide, ozone, radon, and others, as well as particles and microorganisms.

Indoor air is normally managed by Heating, Ventilation and Air-Conditioning (“HVAC”) systems. One of the goals of HVAC systems is to provide a comfortable and healthy environment for building occupants, in terms of temperature, humidity, composition and cleanliness of air. HVAC systems constantly circulate air through the building while continually adjusting its temperature and humidity to maintain a comfortable environment.

It is desirable to reduce VOC levels in indoor air, and ideally to do so without constantly having to replace the air by exhausting indoor air and injecting fresh air.

### SUMMARY OF DISCLOSURE

In some embodiments of the present disclosure, an air treatment assembly is provided with a carbon fiber cloth for cleansing circulating indoor air of VOCs. Accordingly, in some embodiments, the air treatment assembly is provided, which may be configured for in-situ regeneration, using outside air to flush a sorbent and purge the air treatment assembly in a repeatable adsorption-regeneration cycle, allowing a relatively small mass of sorbent to be used for an extended period of time. The regeneration process can be enhanced or accelerated by heating the purge air of the sorbent itself. Other sorbents, catalysts, ions or radiation can be added, for example, to improve removal of certain VOC species or remove other contaminants such as CO₂ or microorganisms.

There is thus provided in accordance with an embodiment of the disclosure an air treatment assembly for reducing VOCs contained in indoor air from an enclosed environment, comprising at least one layer of VOC adsorbent filter supported by a rigid frame or a mesh, an enclosure retaining the VOC adsorbent filter and configured to allow air to flow through the filter, whereby at least some of the VOCs are adsorbed, and a plurality of ports having a plurality of dampers together configured for at least two operation modes including an indoor mode of operation , wherein indoor air is treated for VOC removal, and a filter regeneration mode for in-situ regeneration of the VOC adsorbent filter by a purge gas, and exhausting the purge gas outside of the enclosed environment.

According to some embodiments, the VOC adsorbent filter comprises a carbon fiber cloth comprising a woven fabric or a sheet of intertwined carbon fibers. The carbon fiber cloth may be generally flat. Alternatively, the carbon fiber cloth may be pleated. The enclosure may include a rigid frame, wherein the carbon fiber cloth is supported in the rigid frame.

According to some embodiments, the purge gas comprises outside air. The purge gas may be introduced at a temperature between about 20° C. to about 120° C. The purge gas may be heated by at least one of an electric coil, a hot water coil, a gas furnace, a heat pump, solar heat, and waste heat from a nearby source. The carbon fiber cloth may be heated during the filter regeneration mode by an electric current or by radiation.

According to some embodiments, at least one regenerable sorbent material other than the carbon fiber cloth may be present and configured to remove contaminants from the indoor air and for in-situ regeneration using a purge gas. The additional sorbent may be configured to remove CO₂ from indoor air. The additional sorbent may be a solid supported amine.

There is thus provided in accordance with an embodiment of the disclosure, a permeable air filtration cartridge comprising a rigid frame, at least one sheet of carbon fiber or carbon fiber cloth supported by the frame, and at least one additional solid sorbent material capable of in-situ regeneration, supported by the rigid frame. The additional sorbent material may comprise a granular solid supported by the mesh, and wherein the mesh may be configured to hold the sorbent material and allow air to flow through the cartridge. The additional sorbent material may contain a solid supported amine. The additional sorbent material may be a molecular sieve, a clay, or a porous oxide. The sheet may line at least one interior surface of the cartridge. The cartridge may further comprise at least one additional catalyst material configured to induce a chemical change in at least one contaminant or molecular species in the indoor air. The cartridge may be configured for removable insertion into an air treatment assembly.

There is thus provided in accordance with an embodiment of the disclosure, a method for reducing VOCs contained in indoor air from an enclosed residential or commercial environment, the method comprising providing the air treatment assembly for removing VOCs from indoor air, streaming indoor air containing VOCs from inside the enclosed residential or commercial environment through the assembly, such that the assembly captures at least some of the of the VOCs from the indoor air, and streaming a purge gas, containing less VOCs than the indoor air , through the assembly such that the assembly releases at least some of the captured VOCs to the purge gas.

According to some embodiments, the purge gas may be outdoor air. The purge gas may comprise outside air having a temperature in the range of between about 30° C. to about 120° C. The purge gas may comprise outside air with a temperature less than about 80° C. The purge gas may comprise outside air with a temperature less than about 50° C.

There is thus provided in accordance with an embodiment of the disclosure, a control system for controlling the air treatment assembly, comprising a processor having computer instructions operating thereon for controlling one or more of the dampers, fans and heaters/conditioners associated with the assembly, the instructions comprising instructions for at least the indoor air mode and the filter regeneration mode.

There is thus provided in accordance with an embodiment of the disclosure, an air treatment monitoring system for monitoring the air treatment assembly comprising one or more VOC sensors configured to monitor concentration of VOCs in the air, wherein one or more electronic signals from the one or more sensors are transmitted to the monitoring system and comprise at least one of: inputs for the control system to determine if the air treatment assembly needs to be regenerated, serviced or turned off or on; data for recording and/or monitoring air quality; and data for recording the performance of the air treatment assembly.

According to some embodiments, the VOC sensors may comprise photoionization detectors. Additionally, the VOC sensors may comprise metal oxide sensors. Furthermore, the VOC sensors may comprise differential mobility spectrometers.

### BRIEF DESCRIPTIONS OF THE DRAWINGS

The principles and operations of the systems, apparatuses and methods according to some embodiments of the present disclosure may be better understood with reference to the drawings, and the following description. These drawings are given for illustrative purposes only and are not meant to be limiting.

FIGS. 1A-1C are each a schematic illustration of an air treatment assembly for reducing VOCs according to some embodiments of the present disclosure;

FIGS. 2A-2C are each a schematic illustration of an air treatment assembly for reducing VOCs according to some embodiments of the present disclosure; and

FIG. 3 is a schematic illustration of an air treatment assembly for reducing VOCs according to some embodiment of the present disclosure.

### DETAILED DESCRIPTION

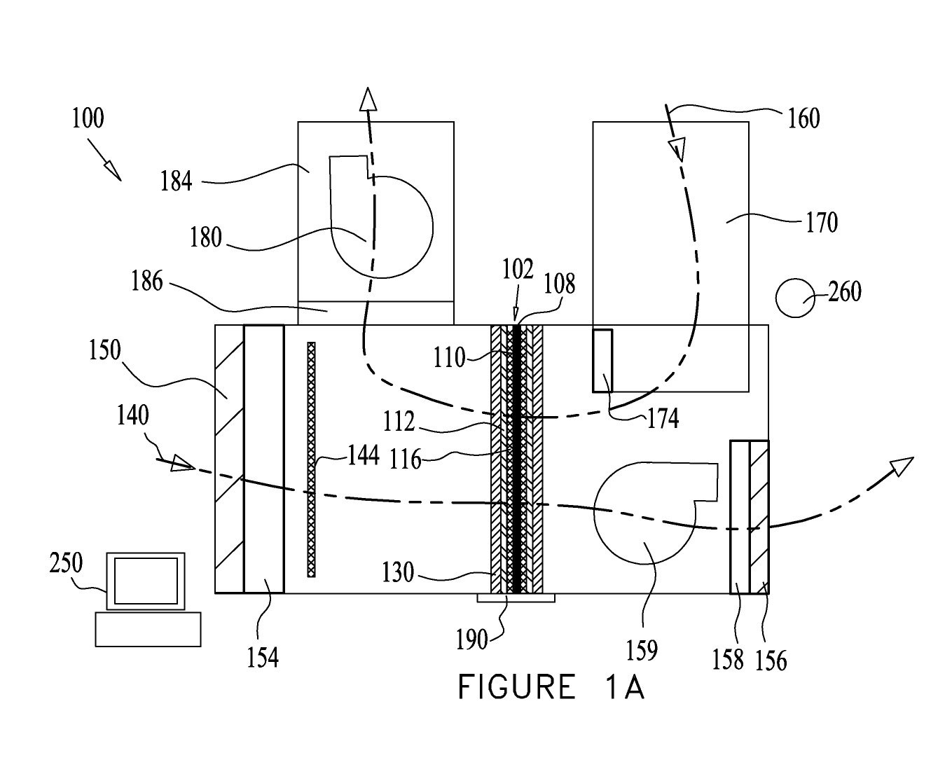

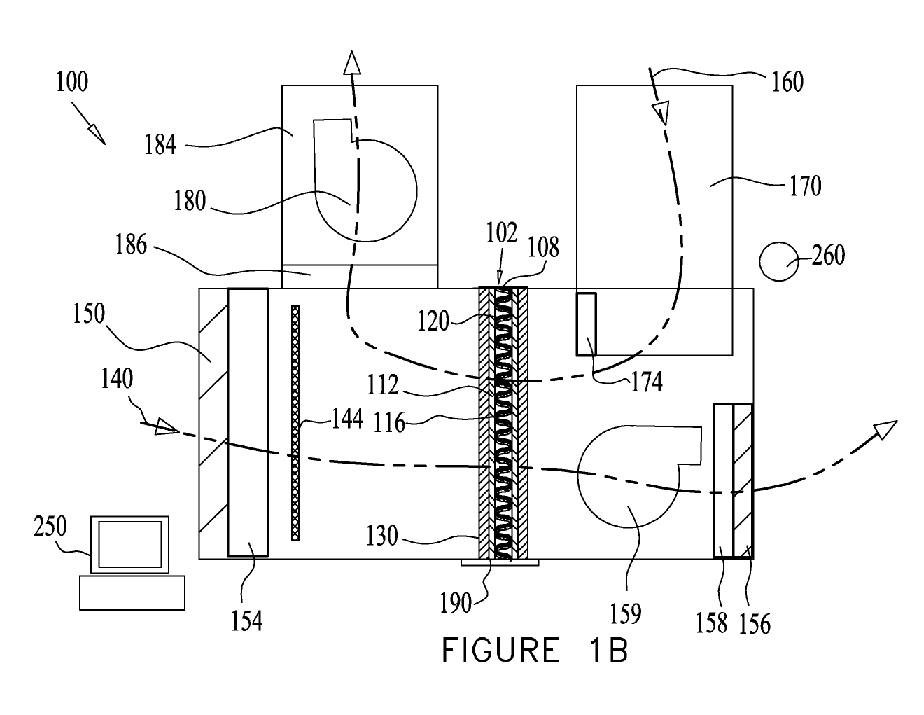

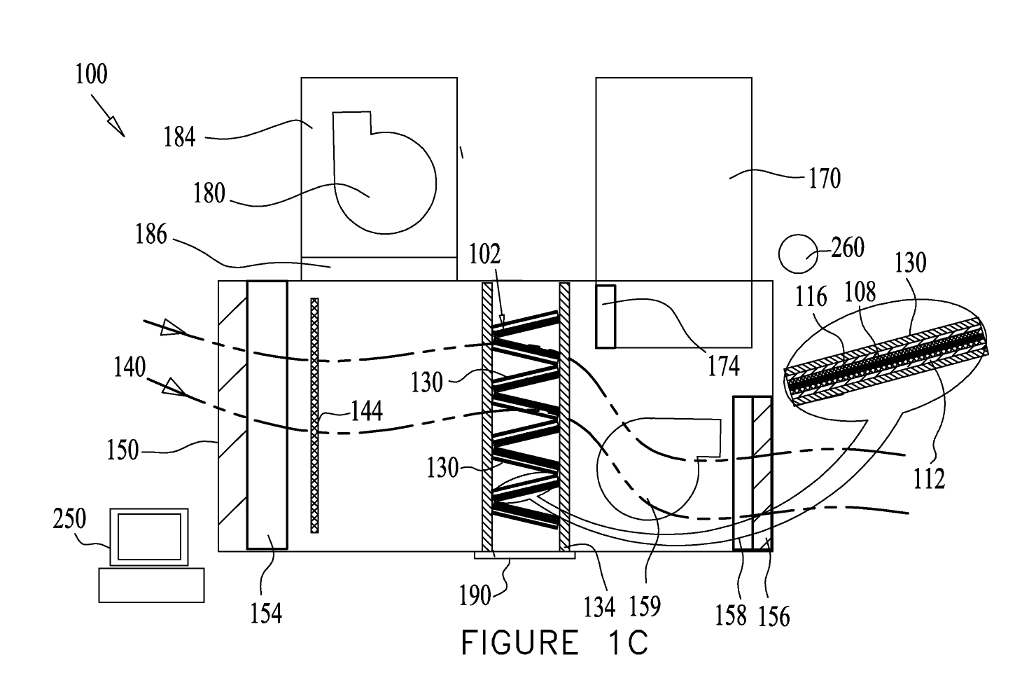

Reference is made to FIGS. 1A-1C, which are each a schematic illustration of an air treatment assembly 100 comprising a VOC adsorbent filter 102 for reducing one or more VOCs in an airflow. Reduction of VOCs may be performed by carbon cloth filters (CCF) formed as, for example, activated carbon fiber cloths 108, or any other suitable means.

The carbon fiber cloth 108 may comprise a woven fabric or a sheet of intertwined carbon fibers. Activated carbon fiber cloths 108 may be commercially available, for example, as the FM-10 ZORFLEX® ACC carbon fiber cloth of Calgon Carbon Corporation. The supple carbon fiber cloth 108 can be formed into uncurved, flat sheets with a relatively flat, straight surface 110 and supported by a frame or a mesh 112, which may be a substantially rigid frame or mesh (mesh, screen and/or other permeable surface; these terms/phrases being used interchangeably), as seen in FIG. 1A. In some embodiments, the carbon fiber cloth 108 can be laminated with a permeable material 116, like filter paper or synthetic fibers, to give it more structural strength, stiffness or protection from dust particles.

In some embodiments, with or without lamination, the carbon fiber cloth 108 can be pleated in an accordion-like form 120, as seen in FIG. 1B. The pleated or curved cloth may also be supported by the frame or mesh 112. In some embodiments, the pleating may increase the surface area and reduce the pressure drop of the flowing air.

In some embodiments, flat or pleated carbon fiber cloths 108 can be inserted into an enclosure 130 comprising a framed (e.g., rectangular) sheet. The enclosure 130 can be constructed of any sufficiently rigid material, such as metal or plastic. In some embodiments, the enclosure 130 may comprise an aluminum frame. In some embodiments, the enclosure 130 may comprise plastic polymers. In some embodiments, the enclosure 130 may comprise frames based on paper, cardboard or recycled materials.

As seen in FIGS. 1A-1C, for example, in some embodiments, the enclosures 130 may be formed as rectangular (for example) sheets; one of skill in the art will appreciate that enclosures comprising frames (and corresponding sheets) may be configured in any suitable configuration. In some embodiments, the enclosures 130 may be formed of a permeable material or configuration for allowing air to flow therethrough.

In some embodiments, the carbon fiber cloth 108 may be formed into one of several commonly used three dimensional filter forms, including but not limited to a V-bank shape. As seen in FIG. 1C, for example, a plurality of carbon fiber cloths 108 supported by enclosures 130 may be provided and arranged in a V-bank arrangement (for example). Supporting walls 134 may also be provided to support the plurality of carbon fiber cloths 108, as shown in FIG. 1C.

In some embodiments, the carbon fiber cloth 108 may be formed as a cylindrical filter (not shown), where air flows radially between an inside and outside surface of the cylinder (for example).

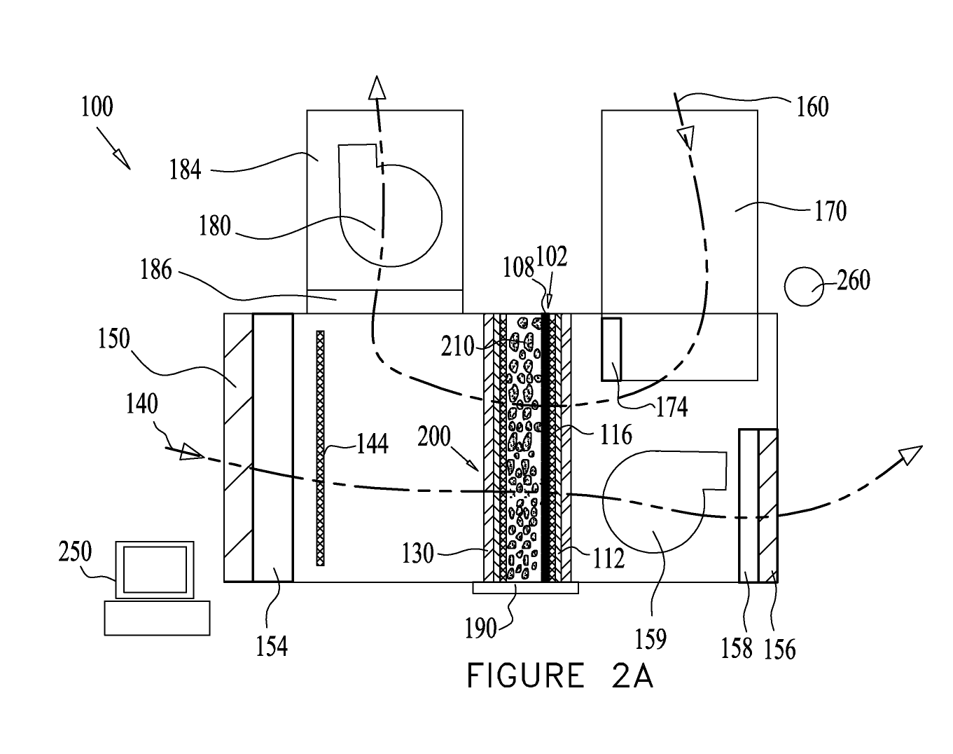

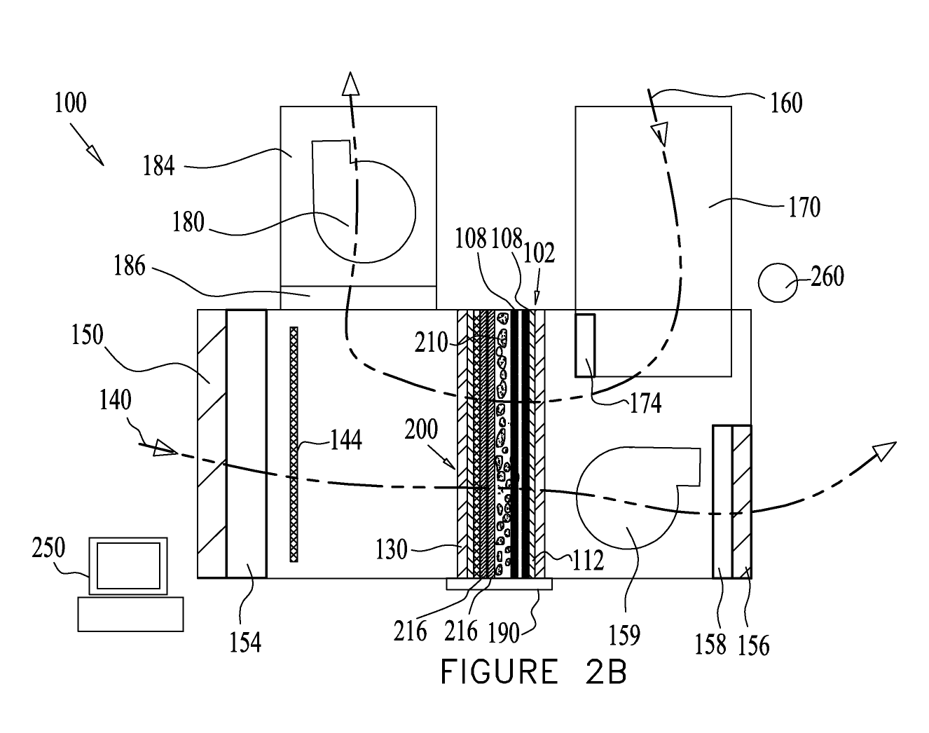

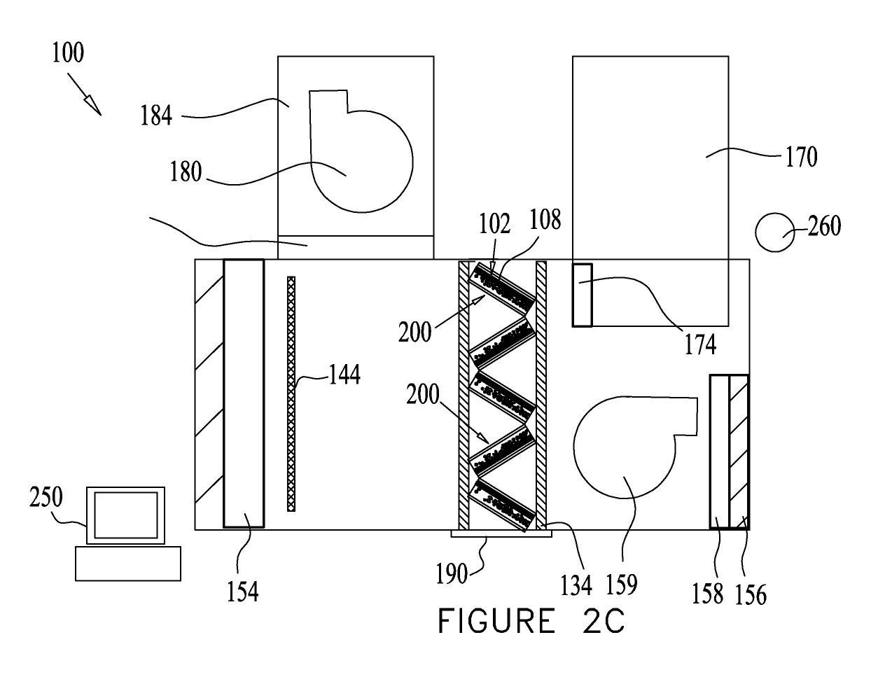

In some embodiments, multiple layers of the carbon fiber cloth 108 can be used to increase the efficiency and capacity of VOC adsorption. Several layers of carbon fiber cloths 110 (e.g., flat, or textured—i.e., with a topography) and/or several layers of pleated carbon fiber cloths 120 can be positioned in parallel, in the same enclosure 130 (for example), as shown in FIG. 2B. In some embodiments, several separately framed layers of carbon fiber cloths 108 (flat, pleated, and/or having a surface topography) can be positioned in series so that air flows through them in sequence, as shown in FIG. 1C.

In any of these configurations, the VOC adsorbent filter 102 comprising the carbon cloth filter (CCF) may be part of the air treatment assembly 100, illustrated in FIGS. 1A-3, the essential feature of which is the ability to regenerate the adsorptive capacity of the carbon fibers (for example). Some embodiments of the VOC adsorbent filter 102, comprising a carbon fiber cloth 108, is shown in FIGS. 1A-3. In FIG. 1A, the VOC adsorbent filter 102 is shown as a flat carbon cloth 110 supported by a mesh or rigid frame 112 within the air treatment assembly 100. The air treatment assembly 100 may be formed with multiple ports, including dampers, valves or shutters (such terms may be used interchangeably in the present application), and may be configured for at least two separate operational modes: at least one mode of operation comprising an indoor air mode where indoor air is treated for VOC removal, and at least one mode for regeneration of the VOC adsorbent filter 102, where it is regenerated by purging the air treatment assembly 100 and exhausting the purge gas outside of an enclosed environment, as will be further described. The indoor air mode may also be referred to as an adsorption mode.

Accordingly, in some embodiments, the carbon fiber cloth 108 may be placed in any suitable location within the air treatment assembly 100. The carbon fiber cloth 108 may be arranged generally perpendicular to a flow orientation of incoming air 140.

A particle filter 144 may also be provided for removing dust and airborne particles from the incoming air 140. The particle filter 144 may be formed of any suitable material, such as a filter paper or synthetic fiber cloth. The particle filter 144 may be placed in any suitable location within the air treatment assembly 100, such as in proximity to an entry port 150. The particle filter 144 may be omitted.

The air treatment assembly 100 operates according to, in some embodiments, at least two operational modes.

In normal, adsorption operation mode (e.g., indoor air mode), incoming air 140 enters through the entry port 150, controlled by a damper 154, whereby the incoming air 140 flows through the carbon fiber cloth 108 and exits via an exit port 156 controlled by a damper 158. In some embodiments, the flow of air is urged by a fan 159 or a blower, which can be placed before or after the carbon fiber cloth 108. In normal operation, the incoming air 140 flowing through the carbon fiber cloth 108 is indoor air originating from an enclosed environment.

The enclosed environment may be an office building, a commercial environment or building, a bank, a residential environment or building, a house, a school, a factory, a hospital, a store, a mall, an indoor entertainment venue, a storage facility, a laboratory, a vehicle, an aircraft, a ship, a bus, a theatre, the cabin of a sea vessel, a partially and/or fully enclosed arena, an education facility, a library and/or other partially and/or fully enclosed structure and/or facility which can be at times occupied by equipment, materials, live occupants (e.g., humans, animals, synthetic organisms, etc.), etc., and/or any combination thereof and which has access to outside air.

The cleaned air, exiting air treatment assembly 100 at exit port 156, may be returned to the enclosed environment. The entire air treatment assembly 100 can be coupled directly to the enclosed environment or can be connected to ducts (not shown) used for heating, ventilation and air conditioning (HVAC).

In some embodiments, the HVAC may be performed in a central HVAC system comprising a central air handling unit. In some embodiments, the HVAC may be performed in a distributed air circulation system comprising one or more fan-coil units. In some embodiments, the assembly may connect directly to the enclosed environment independently of any HVAC system or ductwork.

When the carbon fiber cloth 108, according to some embodiments, is in need of regeneration, the air treatment assembly 100 can be operated, in some embodiments, in a regeneration mode. For example, dampers 154 and 158 may be closed, effectively disconnecting the air treatment assembly 100 from the enclosed environment or the incoming air 140. Purge gas 160 may then be injected though a separate entry port 170 controlled by a damper 174. A fan 180 may be provided to urge the purge gas 160 to flow through the carbon fiber cloth 108 and exit via an exit port 184 and a damper 186.

In some embodiments, the purge gas 160 may comprise outside air, namely air brought from outside the building or other enclosed environment, injected through the air treatment assembly 100 and purged back to the outside of the building or enclosed environment.

In some embodiments the purge gas 160 may comprise a gas containing less VOCs than the indoor air.

The purge gas 160 may flow during the regeneration phase in the opposite direction of the flow of the incoming air 140, from entry port 170 to exit port 184, as shown in Figure lA (according to some embodiments). Alternatively, the purge gas 160 may flow during regeneration in the same direction of the incoming air 140 flow from exit port 184 to entry port 170 (according to some embodiments).

In some embodiments, heat accelerates desorption. For example, the purge gas 160 can be introduced into the air treatment assembly 100 at ambient temperature or heated. The purge gas 160 may regenerate at a relatively low temperature in the range of 20-120° C. Alternatively, the purge gas 160 may regenerate at a temperature less than 80° C. Alternatively, the purge gas 160 may regenerate at a temperature less than 50° C.

In some embodiments, heated purge gas 160 can be used to improve or accelerate the regeneration process. The purge gas 160 can be heated by any number of heat sources, including, for example, a gas furnace, an electric coil, a solar heater, a heat pump, or a coil with hot water or other hot fluid or waste heat from a nearby source. In some embodiments, the carbon fiber cloth 108 is heated directly by an electric current or by radiation such as light or infra-red light configured to reach the carbon cloth filter 100 during the regeneration process.

Certain types of VOCs, including, but not limited to, light species, like formaldehyde and acetone, for example, may not be sufficiently adsorbed by the carbon fibers of the carbon fiber cloth 108 in certain operating conditions. These operating conditions may be, for example, temperature, air flow velocity, and concentration of these species. The removal of these species from the airflow can be further aided by means of catalyst materials that change the molecular structure of these species. In a non-limiting example, catalysts can turn light VOCs into heavier species that are better adsorbed. In another non-limiting example, catalysts can break down VOCs into smaller molecules like CO₂ and water.

The air treatment assembly 100 according to some embodiments may comprise an access door 190 placed at any suitable location, providing access to the VOC adsorbent filter 102. Accessibility may be provided for installation and/or removal of the VOC adsorbent filter 102 from the air treatment assembly 100, such as when maintenance activities are required, typically wherein the VOC adsorbent filter 102 reaches the end of its prescribed operating life and needs to be replaced.

In some embodiments, removal of other contaminants, such as CO₂, requires a solid sorbent. The solid sorbent may comprise a granular sorbent or any other suitable sorbent. It has been previously described in applicant's US Patent Publication No. 20110198055, which is incorporated herein by reference in its entirety, how in-situ regenerable granular sorbents can be formed into cartridges and assemblies for treating indoor air. Thus, according to some embodiments of the present disclosure, granular sorbents may be combined with carbon cloth filters into a cartridge that contains both, and thus, may be capable of removing a larger number of contaminants, for example CO₂ and VOCs, which together represent the most common indoor gas contaminants.

In some embodiments, the removal of CO₂ from the air is achieved by a sorbent based on solid supported amines, as was described, for example, in applicant's PCT application PCT/US12/038343, which is incorporated herein by reference in its entirety.

FIGS. 2A-2C each illustrates some embodiments of a sorbent cartridge 200 including a VOC filtration cartridge that comprises solid sorbent 210 as well as a layer of carbon fiber cloth 108. Air flowing through the cartridge 200 may come into contact first with the solid sorbent 210 and then with the carbon fiber cloth 108, thereby being at least in part cleansed of the gas species that are captured by the solid sorbent 210 and subsequently flowing to the carbon fiber cloth 108. Alternatively, the air flowing through the cartridge 200 may come into contact first with the carbon fiber cloth 108.

In some embodiments, the carbon fiber cloth 108 lines an interior of mesh 112 of the cartridge 200 that holds the solid sorbent 210. The sorbent cartridge 200 may further include, according to some embodiments, permeable material 116, and the enclosure 130. The combination of the carbon fiber cloth 108 and the solid sorbent 210 in the same cartridge 200, as seen in FIG. 2A, presents a simplified deployment of the solution, i.e., contaminant removal from air, and determines that adsorption and regeneration of the two materials will be concurrent (according to some embodiments).

As described above, in some embodiments, several layers of flat carbon fiber cloths 108 may be positioned in parallel, and in the same cartridge 200, as shown in FIG. 2B. The sorbent cartridge 200 may also comprise an additional sorbent 216 for removal of other contaminants and may be formed in any suitable configuration. The additional sorbent 216 may be formed as a layer or slab and a single or plurality of layers may be provided, as shown in FIG. 2B.

In FIG. 2C, a plurality of sorbent cartridges 200 may be provided and arranged in a V-bank arrangement or any other suitable arrangement, according to some embodiments. In FIG. 2C, the sorbent cartridges 200 may be configured as shown in FIG. 2A, though the sorbent cartridges 200 may be configured as shown in FIG. 2B.

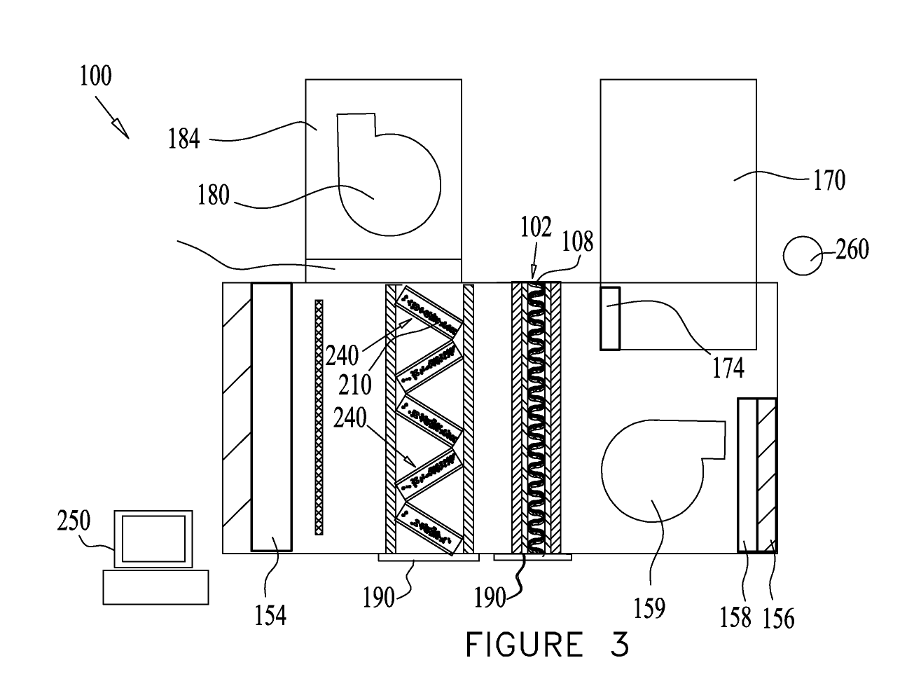

In FIG. 3, a plurality of sorbent cartridges 240 may be provided and arranged in a V-bank arrangement, for example, according to some embodiments. In such embodiments, the sorbent cartridges 240 may comprise the granular sorbent 210 and the carbon fiber cloth 108 may be provided in a substantially perpendicular orientation in respect to the plurality of sorbent cartridges 240. The carbon fiber cloth 108 may be provided upstream, i.e., before the sorbent cartridges 240. Alternatively, the carbon fiber cloth 108 may be provided downstream, i.e., after the sorbent cartridges 240, as shown in FIG. 3. In FIG. 3 the carbon fiber cloth 108 is shown pleated, though a flat carbon fiber cloth 108 may be provided, or one with surface topography that, for example, increases surface area. Additionally, a plurality of carbon fiber cloths 108 may be provided (according to some embodiments).

The cartridges 200 shown in FIGS. 2A-2C and cartridges 240 of FIG. 3, may be configured for removable insertion into the air treatment assembly 100, such as via access door 190.

In some embodiments, the air treatment assembly 100 may be operated with the help of control system 250 which may comprise an automated electromechanical control unit that determines at what time or period to open or close one or more of dampers 154 and 158, for example, when to activate one or more fans 159 and 180, responsible for flowing air through the air treatment assembly 100, for example, when to activate a heating (or cooling) component, that is configured to heat the purge gas 160, and also when to signal for a service call if necessary, for example.

The control system 250 may comprise a processor having computer instructions operating thereon for controlling one or more of the dampers, fans and heaters/conditioners associated with the air treatment assembly 100. The instructions may comprise instructions operating the adsorption mode (i.e. the indoor mode of operation) and the regeneration mode.

To assure the air quality as well as the performance and benefits of the VOC removal system, in some embodiments, detection and/or monitoring functionality for detecting and/or monitoring of VOC levels in the air is provided. An air treatment monitoring system, for monitoring an air treatment assembly for reducing VOCs contained in indoor air, may comprise one or more sensors 260 configured to monitor concentration of VOCs in the air stream, wherein one or more electronic signals from the sensors 260 are transmitted to the monitoring system and comprise at least one of inputs for the control system to determine if the air treatment assembly 100 needs to be regenerated, serviced or turned off or on, data for recording and/or monitoring air quality, and data for recording the performance of the air treatment assembly 100.

The sensors 260 and/or systems are capable of measuring concentrations of specific VOC species and/or total VOC concentration and can be installed upstream and/or downstream from the VOC removal system, and/or in other suitable locations in the building or the enclosed environment. The measurements can be electronically transmitted, by wireline or wireless signals, to the control system that monitors, records and controls the operation of the VOC removal assembly, or simply to a recording unit to collect and save the measured data.

Sensing of the VOC concentrations can be done in any number of ways. In some embodiments, a photoionization detector unit may be provided to measure total VOCs. In some embodiments, a differential mobility spectrometer can be provided to detect specific species of contaminants. In some embodiments, metal-oxide VOC sensors can also be used, as can infrared spectrometers. In some embodiments, any other suitable sensor that is sensitive to the target VOC species can be used for this purpose.

Although a few variations have been described in detail above, other modifications are possible. For example, any logic flows depicted in the accompanying figures and described herein does not require the particular order shown, or sequential order, to achieve desirable results. Other implementations may be within the scope of at least some of the following exemplary claims.

Example embodiments of the devices, systems and methods have been described herein. As may be noted elsewhere, these embodiments have been described for illustrative purposes only and are not limiting. Other embodiments are possible and are covered by the disclosure, which will be apparent from the teachings contained herein. Thus, the breadth and scope of the disclosure should not be limited by any of the above-described embodiments but should be defined only in accordance with claims supported by the present disclosure and their equivalents. Moreover, embodiments of the subject disclosure may include methods, systems and devices which may further include any and all elements from any other disclosed methods, systems, and devices, including any and all elements corresponding to translocation control. In other words, elements from one or another disclosed embodiments may be interchangeable with elements from other disclosed embodiments. In addition, one or more features/elements of disclosed embodiments may be removed and still result in patentable subject matter (and thus, resulting in yet more embodiments of the subject disclosure).

1. An air treatment assembly for reducing VOCs contained in indoor air from an enclosed environment, comprising:
at least one layer of VOC adsorbent filter supported by a rigid frame or a mesh;
an enclosure retaining the VOC adsorbent filter and configured to allow air to flow through the filter, whereby at least some of the VOCs are adsorbed; and
a plurality of ports having a plurality of dampers together configured for at least two operation modes including an indoor mode of operation wherein indoor air is treated for VOC removal and a filter regeneration mode for in-situ regeneration of the VOC adsorbent filter by a purge gas and exhausting the purge gas outside of the enclosed environment.

2. The assembly according to claim 1, wherein the VOC adsorbent filter comprises a carbon fiber cloth comprising a woven fabric or a sheet of intertwined carbon fibers.

3. The assembly according to claim 2, wherein the carbon fiber cloth is generally flat.

4. The assembly according to claim 2, wherein the carbon fiber cloth is pleated.

5. The assembly according to claim 2, wherein the enclosure includes a rigid frame and wherein the carbon fiber cloth is supported in the rigid frame.

6. The assembly according to claim 1, wherein the purge gas comprises outside air.

7. The assembly according to claim 1, wherein the purge gas is introduced at a temperature between about 20° C. to about 120° C.

8. The assembly according to claim 1, wherein purge gas is heated by at least one of: an electric coil, a hot water coil, a gas furnace, a heat pump, solar heat, and waste heat from a nearby source.

9. The assembly according to claim 2, wherein the carbon fiber cloth is heated during the filter regeneration mode by an electric current or by radiation.

10. The assembly of claim 2, where at least one regenerable sorbent material other than the carbon fiber cloth is present and configured to remove contaminants from the indoor air and for in-situ regeneration using a purge gas.

11. The assembly of claim 10, where the additional sorbent is configured to remove CO₂ from indoor air.

12. The assembly of claim 10 where the additional sorbent is a solid supported amine.

13. A permeable air filtration cartridge comprising:
a rigid frame;
at least one sheet of carbon fiber or carbon fiber cloth supported by the frame; and at least one additional solid sorbent material capable of in-situ regeneration, supported by the rigid frame.

14. The cartridge of claim 13, further comprising a mesh, wherein the additional sorbent material comprises a granular solid supported by the mesh, and wherein the mesh is configured to hold the sorbent material and allow air to flow through the cartridge.

15. The cartridge of claim 13, where the additional sorbent material contains a solid supported amine.

16. The cartridge of claim 13, where the additional sorbent material is a molecular sieve, a clay, or a porous oxide.

17. The cartridge of claim 13, where the sheet lines at least one interior surface of the cartridge.

18. The cartridge of claim 13, further comprising at least one additional catalyst material configured to induce a chemical change in at least one contaminant or molecular species in the indoor air.

19. The cartridge of claim 13 wherein the cartridge is configured for removable insertion into an air treatment assembly.

20. A method for reducing VOCs contained in indoor air from an enclosed residential or commercial environment, the method comprising:
providing the air treatment assembly of claim 1 for removing VOCs from indoor air; streaming indoor air containing VOCs from inside the enclosed residential or commercial environment through the assembly such that the assembly captures at least some of the of the VOCs from the indoor air; and
streaming a purge gas, containing less VOCs than the indoor air, through the assembly such that the assembly releases at least some of the captured VOCs to the purge gas.

21. A method according to claim 20, wherein the purge gas is outdoor air.

22. A method according to claim 20, wherein the purge gas comprises outside air having a temperature in the range of between about 20° C. to about 120° C.

23. A method according to claim 20, wherein the purge gas comprises outside air with a temperature less than about 80° C.

24. A method according to claim 20, wherein the purge gas comprises outside air with a temperature less than about 50° C.

25. The assembly of claim 1 further comprising a control system comprising a processor having computer instructions operating thereon for controlling one or more of the dampers, fans, heaters, and conditioners associated with the assembly, the instructions comprising instructions for at least the indoor air mode and the filter regeneration mode.

26. The assembly of claim 25 further comprising an air treatment monitoring system comprising one or more VOC sensors configured to monitor concentration of VOCs in the air, wherein one or more electronic signals from the one or more sensors are transmitted to the monitoring system and comprise at least one of:
inputs for the control system to determine if the assembly needs to be regenerated, serviced or turned off or on,
data for recording and/or monitoring air quality, and data for recording the performance of the assembly.

27. The system of claim 26, wherein the VOC sensors comprise photoionization detectors.

28. The system of claim 26, wherein the VOC sensors comprise metal oxide sensors.

29. The system of claim 26, wherein the VOC sensors comprise differential mobility spectrometers.
